(19) United States
(12) Patent Application Publication
(10) Pub. No.: US 2022/0143924 A1
(43) Pub. Date: May 12, 2022

(54) Fluid treatment of 3D printed objects

(71) Applicant: Hewlett-Packard Development Company, L.P., Spring, TX (US)

(72) Inventors: Miguel Vega Velasco, Sant Cugat del Valles (ES); Alejandro Torres Pinero, Sant Cugat del Valles (ES); Eduard Galdeano Castillo, Sant Cugat del Valles (ES)

(73) Assignee: Hewlett-Packard Development Company, L.P., Spring, TX (US)

(21) Appl. No.: 17/416,174

(22) PCT Filed: Jul. 30, 2019
(86) PCT No.: PCT/US2019/044106

§ 371 Date: Jun. 18, 2021

(51) Int. Cl. B29C 64/393; B33Y 50/02; G01G 17/06; G01G 19/52; B33Y 30/00

(52) U.S. Cl. CPC B29C 64/393; B33Y 50/02; B33Y 30/00; G01G 19/52; G01G 17/06

(57) ABSTRACT

Apparatus is described comprising a chamber (101), which further comprises an interior (130), a sensor (102), a fluid dispenser (103) and a controller (104). A 3D printed object can be disposed in the chamber (101). The sensor (102) is arranged to weigh the chamber (101) or the whole contents of the chamber (101). The fluid dispenser (103) is arranged to dispense fluid into the interior (130) of the chamber (101) and the controller (104) can determine the weight of the 3D printed object and control the fluid dispenser (103). A system and a non-transitory machine-readable storage medium encoded with instructions executable by a processor.

### BACKGROUND

3D printed objects can be post-processed after printing by exposure to a fluid, such as water vapor, steam or a vaporised solvent. During this process the 3D printed object interacts with the fluid and/or absorbs the fluid to achieve its final composition. Examples of 3D printed objects that can be treated include objects generated from plastics, ceramics and resins. The choice of fluid may depend on the type of material from which the 3D printed object to be treated is made.

### BRIEF DESCRIPTION OF THE DRAWINGS

FIG. 1 is a schematic representation of an example of apparatus;

FIG. 2 is a schematic representation of another example of apparatus;

FIG. 3 is a schematic representation of another example of apparatus in use;

FIG. 4 is an example of a chamber;

FIG. 5A is a schematic representation of an example of a system;

FIG. 5B is a schematic representation of another example of a system;

FIG. 6 is a flow diagram of an example of a system; and

FIG. 7 is block diagram of example instructions executable by a processor.

### DETAILED DESCRIPTION

A number of examples will be discussed in detail below. Where like parts in different Figures are discussed, the same reference numeral will be used.

3D printed objects may be treated using a range of different treatment agents. These 3D printed objects can be post-processed after printing by exposure to a fluid, such as water vapor, steam or a vaporised solvent. Polyamide is a frequently used material for producing 3D printed objects. Polyamides, along with many other materials, are able to absorb water from the environment until they are fully saturated. Some examples of 3D printing materials that may absorb water from the environment include nylon 11 (PA11), nylon 12 (PA12) and thermoplastic polyurethane (TPU). It may be beneficial to expose 3D printed objects to a controlled environment that allows them to interact with the fluid and/or absorb the fluid. If the process is not carried out in a controlled environment, the process can take considerably longer or may not be effective with the result that a 3D printed object does not absorb sufficient fluid. In one example, a 3D printed object may be exposed to water vapor. In another example, it may be beneficial for a 3D printed object to be exposed to a vaporised solvent or a specific amount of vaporised solvent. During this process the weight of the 3D printed object will change. The change in weight may be an increase or a decrease compared to the starting weight of the 3D printed object. For example, if a 3D printed object is exposed to water vapor, the weight of the object may increase. In another example, if the 3D printed object is exposed to certain chemical solvents that may react to remove a certain amount of the surface material of the 3D printed object, the weight may decrease.

If the process of exposing 3D printed objects to fluids is not monitored, the objects may be overexposed resulting in the user spending more time and resources than is needed to produce the final product. By exposing 3D printed objects, such as those made from polyamides, to fluids, such as water vapor, steam or other vaporised solvents, and measuring the change in weight of the 3D printed object before, during and/or after exposure, or a combination thereof, the process for producing stable 3D printed objects can be accelerated and controlled.

The present disclosure provides an apparatus, a system and a non-transitory machine-readable storage medium which may be encoded with instructions executable by a processor that can be used for treating 3D printed objects to fluids.

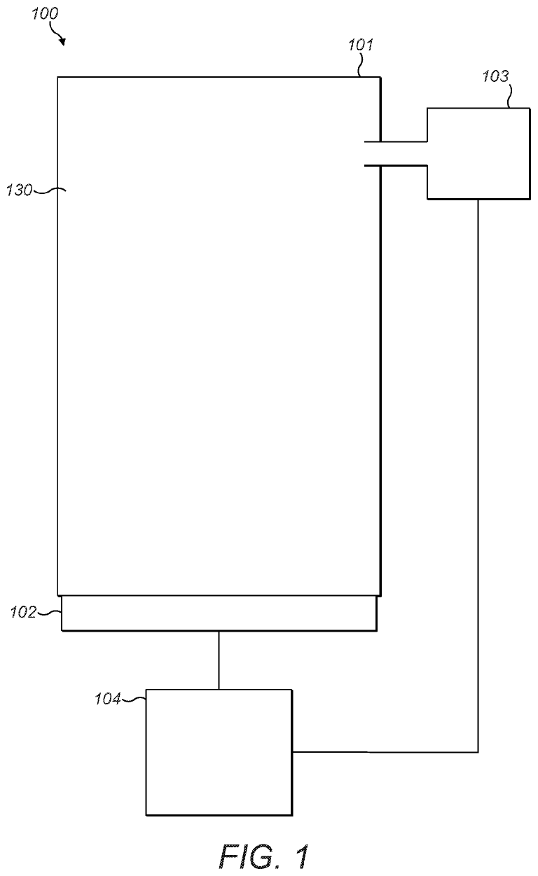

One example of an apparatus that can be used for treating 3D printed objects is shown in FIG. 1.

The treatment of a 3D printed object is conducted with apparatus, generally indicated 100. The apparatus includes a chamber 101, having an interior 130, into which a 3D printed object (not shown) can be disposed. The apparatus also comprises a sensor 102 arranged to weigh the chamber 101 or the contents of the chamber 101, a fluid dispenser 103 arranged to dispense fluid into the interior 130 of the chamber, and a controller 104 that can determine the weight of the 3D printed object and control the fluid dispenser 103. The chamber 101 can be of any size or shape, depending on the size or quantity of 3D printed objects to be treated. The chamber 101 may be made, for example, of a material such as plastic, metal or glass, or a combination thereof. The chamber 101 during use may hold one 3D printed object or multiple 3D printed objects for treatment. The apparatus may further comprise one or more trays onto which the 3D printed object can be disposed.

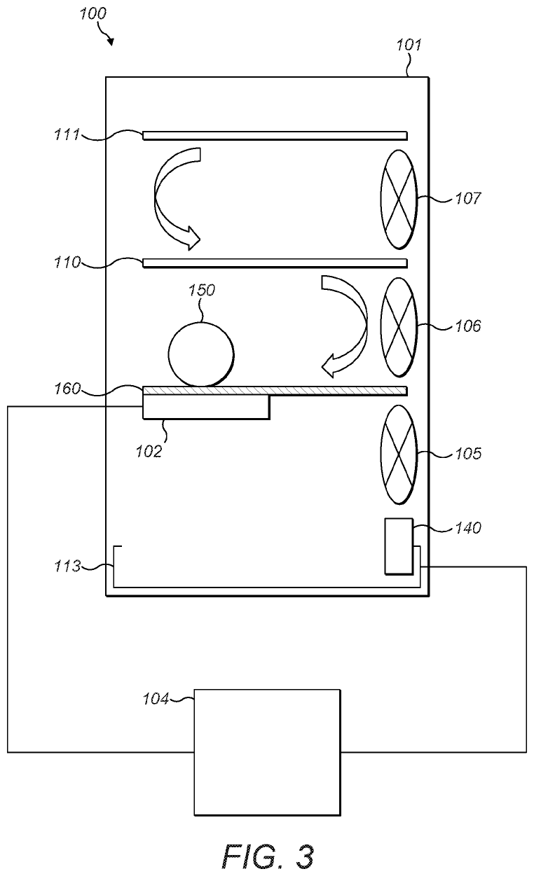

The sensor 102 is arranged to weigh the chamber 101 or the contents of the chamber 101. In one example the sensor 102 may do this by weighing the chamber 101 itself. In this example, the sensor 102 may be located in, on or under the chamber 101. In another example, the sensor 102 may be arranged to weigh only the contents of the chamber 101. In this example, the sensor 102 may be located within the chamber. The sensor 102 can be calibrated to account for the weight of the chamber 101 and/or the contents within the chamber 101 and as such, calculate the weight of only the 3D printed object. The contents may include the entire contents of the chamber or only those items which the sensor 102 is in contact with. In another example, the sensor 102 may be located in, on or under a tray 160 onto which a 3D printed object is disposed, such as when fluid is present in a water tank or container 113, as shown in FIG. 3. In this example, the sensor 102 may only weigh the tray and the 3D printed object or objects and be calibrated to determine the weight of only the 3D printed object or objects. The position and configuration of the sensor 102 in the apparatus may be applied to the system discussed below.

The sensor 102 may be an electronic sensor. The sensor 102 may be any suitable electronic sensor for weighing the contents of the chamber 101 and can be exposed to fluids such as water, water vapor, steam or vaporised solvent. The sensor 102 can be calibrated to calculate the weight of the 3D printed object. Therefore, this information can be recorded and the increase or decrease in weight can be monitored.

The fluid dispenser 103 is arranged to dispense fluid into the interior 130 of the chamber 101. The fluid dispenser may be arranged to dispense fluid into the interior of the chamber to interact with the 3D printed object. The fluid dispenser may be arranged to dispense fluid into the interior of the chamber to be absorbed by the 3D printed object. The fluid dispenser may be arranged to dispense fluid into the interior of the chamber to interact with the 3D printed object or to be absorbed by the 3D printed object. The interaction of the fluid with the 3D printed object may comprise the fluid reacting with the 3D printed object, the fluid dissolving upon contact with the 3D printed object, and/or the fluid contacting the 3D printed object. The apparatus may comprise a fluid dispenser 103, wherein the fluid dispenser 103 is a water vapor dispenser. The fluid dispenser 103 may be in the form of a steam injector, a humidifier, a sprinkler, a container 113, a water tank, water vapor dispenser or any combination thereof. The fluid dispenser 103 may be a steam injector to produce the fluid in the form of vaporised water, or the fluid dispenser 103 may be a water tank or a container 113 that may provide the fluid which is then vaporised within the chamber 101. A water tank or container 113, as shown in FIG. 3, may be uncovered or open topped, such that the fluid is exposed to the interior 130 of the chamber 101. The fluid dispenser 103 may also be capable of extracting fluid from the interior 130 of the chamber 101 to outside of the chamber 101. In one example, there may be a separate extractor (not depicted) in the chamber 101 for extracting fluid from the interior 130 of the chamber 101 to outside of the chamber 101. The fluid may be, but is not limited to, water, water vapor, steam or a solvent. The solvent may be xylene, toluene, water, alcohols, methylene chloride, n-propyl bromide, perchloroethylene, trichloroethylene, acetone, methyl ethyl ketone, dimethylacetamide, or a combination thereof. The fluid may be any other suitable gas, liquid or vapor that can be used for the post-processing treatment of 3D printed objects.

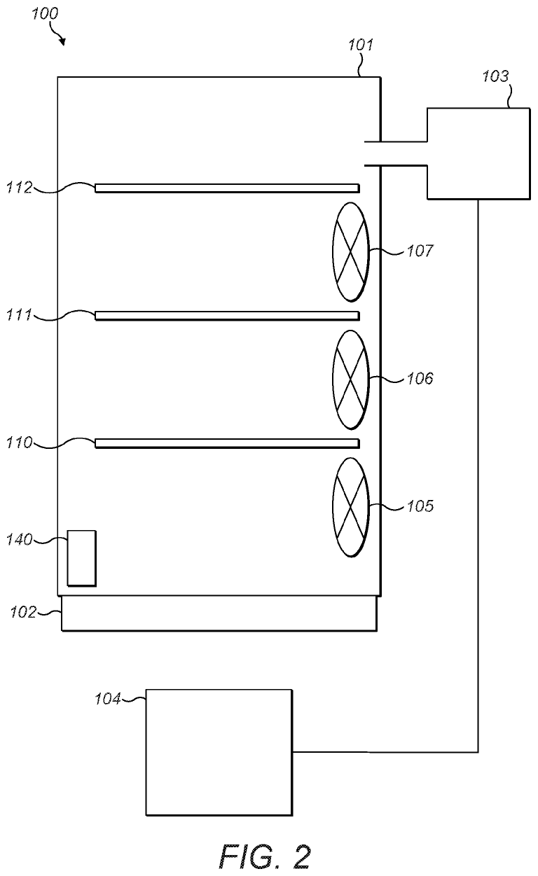

The apparatus may comprise a fan 105 arranged within the chamber 101. The apparatus may comprise a condenser 110 arranged within the chamber 101. The apparatus may also comprise one or more fans 105, 106, 107, as depicted in FIG. 2, one or more condensers 110, 111, 112, as depicted in FIG. 2, and one or more heaters 140, as depicted in FIG. 2, to circulate and condense the fluid around the interior 130 of the chamber 101. The apparatus may have any number of fans, condensers and/or heaters, and the number and arrangement of these features may be optimised depending on the size and shape of the chamber 101 and also the size and number of 3D printed objects to be treated. The configuration and benefits of the fans, condensers and heaters are discussed below.

The controller 104 is connected to the sensor 102. The controller 104 can determine the weight of the 3D printed object in the chamber 101 and control the fluid dispenser 103. The controller 104 may be physically connected to the sensor 102 or the connection may be wireless. The controller 104 may also be physically connected to the fluid dispenser 103 or the connection may be wireless. The controller 104 can start the fluid dispensing process. The fluid dispensing process may be set to occur for a pre-set period of time so that a certain volume of fluid is dispensed. The controller 104 is set to stop the fluid dispenser 103 once a pre-set period of time has passed, allowing the amount of volume that is dispensed into the chamber 101 to be controlled. This dispensing process can be done for a time period that is pre-programmed into the controller 104 or manually set into the controller 104 by the user. The time period will depend on the amount of volume that needs to be dispensed. The volume will depend on the size and the amount of 3D objects present and the size of the chamber 101. For example, if the fluid dispenser 103 is in the form of a steam injector, a humidifier or a sprinkler, the controller 104 can start the injector, humidifier or sprinkler, allowing fluid or fluid vapor to be introduced into the interior 130 of the chamber 101. As another example, if the fluid dispenser 103 is in the form of a water tank or container 113, the controller 104 can turn on a heater 140 to produce fluid or fluid vapor in the interior 130 of the chamber 101.

The controller 104 can determine the weight of the 3D printed object or 3D printed objects by receiving input from the sensor 102. The controller 104 may receive information from the sensor 102 as to the weight of 3D printed object before the addition of any fluid, as the sensor is calibrated to take account of the weight of the chamber 101 or the whole contents of the chamber 101. The controller 104 can start the fluid dispenser 103, allowing fluid into the chamber 101 and also stop the fluid dispenser 103. The controller 104 may stop the fluid dispenser 103 after a pre-set period of time. Any 3D printed objects present in the chamber 101 may then start to interact and/or absorb any fluid that is in the chamber 101. After a pre-set period of time, the controller 104 may start the process of the fluid dispenser 103 extracting any fluid from the chamber 101 or the controller 104 may start and stop a separate fluid extractor if present (not depicted). The process of fluid extraction is then stopped by the controller 104. The controller 104 may then receive information from the sensor 102 as to the weight of the 3D printed object once the fluid has been extracted from the chamber. The change in weight before the addition of fluid and after the addition of fluid can be used as a measure of how much fluid has interacted and/or been absorbed by the 3D printed object or objects. The controller 104 may start the fluid dispenser 103 again if the 3D printed object or objects has not reached a predetermined weight. This cycle may be repeated until the 3D printed object or objects have reached the predetermined weight. The predetermined weight may be pre-programmed in to the controller 104. This may be done by connecting the controller 104 to a processor or computer that calculates the predetermined weight based on the composition of the 3D printed object, the structure of the 3D printed object and the final desired level of absorption. The predetermined weight may also be pre-programmed in to the controller 104 by the user. The predetermined weight may be calculated based on the weight of the 3D printed object or objects, the fluid that is used and/or the material used in the 3D printed object or objects and the final levels of absorption that the user wants to achieve at the end of this process. The controller 104 may also comprise a display which alerts the user once the process is complete or the controller may be connected to an additional display which alerts the user once the process is complete. The controller 104 may receive information from the sensor 102 continuously or it may receive information at specific time periods depending on the sensor 102 that is being employed and where it is located. For example, when the sensor 102 is weighing the chamber 101 or the whole contents of the chamber 101, the controller 104 may receive information from the sensor 102 before the addition of the fluid and after the removal of the fluid. These time periods may be pre-programmed in to the controller 104 or may be set by the user. These time periods will be determined based on the amount of 3D printed objects that are being treated, the composition of the 3D printed objects and the required levels of absorption and/or interaction.

The benefits of this apparatus is that it allows the process of treating 3D printed objects with a fluid, such as water, water vapor, steam or vaporised solvent, to be faster and more cost efficient. The apparatus allows for the process to be controlled and monitored, preventing the use of excess fluids and saving time. The apparatus is not limited to be used with one specific fluid and allows for 3D printed objects to be treated with any suitable fluid.

An example of the apparatus is also shown in FIG. 2.

The apparatus may comprise one or more heaters 140 located in the chamber 101 to heat and vaporise any fluid that is present. The heater 140 may be located in the fluid dispenser 103 at the bottom of the chamber 101, to the side of the chamber 101, in the top region or the bottom region of the chamber 101. One example of a heater 140 is a heating element. Such a heating element may be located in the fluid dispenser 103. The heater 140 may be located in any position where it can increase the temperature of the fluid or the fluid vapor. This can be done by being in direct contact with the fluid or by increasing the temperature of the chamber 101. There may be one or more heaters 140 present. The location and number of heaters 140 will depend on the size and contents of the container 113, and the amount of 3D printed objects to be treated.

The apparatus may comprise one or more fans 105, 106, 107 arranged within the chamber to circulate the vapor. One or more condensers 110, 111, 112 may also be present within the chamber 101 to condense any vapor. Condensers 110, 111, 112 may be in the form of any suitable condenser 110, 111, 112 that condenses a fluid from its gaseous state to its liquid state. For example, the condensers 110, 111, 112 may be in the form of metal refrigerated bars.

FIG. 3 is an example of apparatus in use wherein the fluid dispenser 103 is in the form of a container 113 uncovered or open topped.

In FIG. 3, the apparatus in use comprises the user disposing a 3D printed object 150 or objects onto a tray 160 in the interior 130 of a chamber 101. The sensor 102 is positioned under the tray 160. The sensor 102 is then calibrated to account for the weight of the tray 160 and determine the weight of only the 3D printed object 150 or objects. The user starts the controller 104. The predetermined final weight of the 3D printed object 150 or objects is either pre-programmed by the controller 104 or set by the user. This may be done by connecting the controller 104 to a processor or computer that calculates the predetermined weight based on the composition of the 3D printed object, the structure of the 3D printed object and the final desired level of absorption. The predetermined weight may also be calculated by the user based on the weight of the 3D printed object or objects, the fluid that is used and/or the material used in the 3D printed object or objects and the final levels of absorption and/or interaction that the user wants to achieve at the end of this process. The controller 104 is programmed to receive information from the sensor 102 before the addition of any fluid as to the weight of the 3D printed object. The sensor 102 is calibrated to calculate the weight of only the 3D printed object. The controller 104 starts the process of fluid dispensing, by turning on the heater 140. The fluid present in the container 113 is heated and turned into a vaporised form, such as water vapor, steam or vaporised solvent, which interacts with or is absorbed by any 3D printed object 150 or objects disposed onto a tray 160 in the interior 130 of the chamber 101. The controller 104 then turns off the fluid dispenser after a pre-set period of time. The vaporised solvent is circulated throughout the interior 130 of the chamber 101 by one or more fans 105, 106, 107. The condensers 110, 111, 112 help to condense the vaporised fluid back into a fluid, which can then be reheated and recirculated. After a pre-set period of time, the controller 104 starts the process of fluid extraction, either through the fluid dispenser 103, or by starting a separate extractor (not depicted). The controller 104 then stops the extraction process. The controller 104 is programmed to receive information from the sensor 102 after the extraction of the fluid. The controller 104 checks whether the 3D printed object or objects have reach the predetermined weight. If they have, the controller 104 alerts the user, via a display, that the process has completed. If they have not, the controller starts the process again.

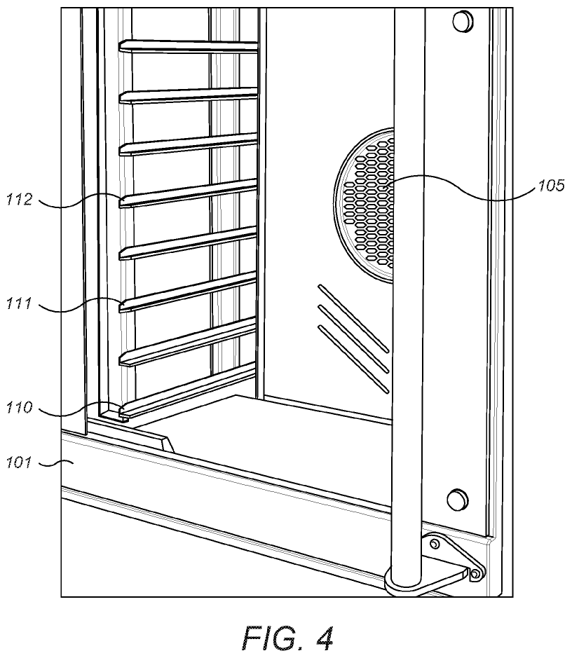

FIG. 4 shows one example of a possible configuration of the condensers 110, 111, 112. The condensers are located throughout the height of the chamber 101. In a process whereby the fluid is dispensed into the chamber 101 and the fluid dispenser 103 is stopped, it may be beneficial to employ one or more condensers 110, 111, 112 in the apparatus. The benefit of employing a condenser 110, 111, 112 is that once the fluid vapor has condensed, the resulting fluid can be reused, which saves costs and reduces the amount of fluid that may be used and the size of the fluid dispenser 103 that may be used. The number and arrangement of the fans 105, 106, 107 and condensers 110, 111, 112 may be optimised depending on the size and shape of the chamber 101 and also the quantity of the 3D printed objects to be treated.

The present disclosure also provides a system that can be used for treating 3D printed objects. The system may include one or more of the features, and the associated benefits, that have already been disclosed in reference to the apparatus.

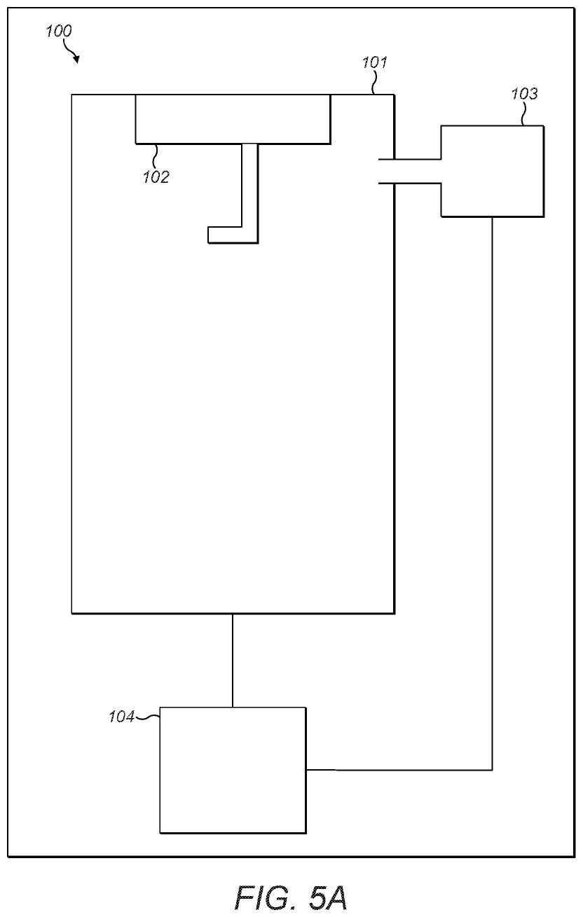

The system, examples of which are depicted in FIGS. 5A and 5B, comprises a chamber 101, having an interior 130, into which a 3D printed object can be disposed. The system also comprises a fluid dispenser 103 arranged to dispense fluid into the interior of the chamber to interact with the 3D printed object or to be absorbed by the 3D printed object, and a sensor 102 that can weigh a 3D printed object in the chamber 101. The sensor 102 may be an electronic sensor. The sensor 102 may be arranged to weigh only the 3D printed object. FIG. 5A shows one possible arrangement for a sensor 102 that weighs only the 3D printed object. In this example, such a sensor 102 may be in the form of an electronic hanging scales to which the 3D printed object or objects can be attached. The sensor 102 may also be arranged to weigh the chamber or the contents of the chamber 101 and then calculate the weight of the 3D printed object. FIG. 58 shows one possible arrangement for a sensor 102 that weighs the contents of the chamber 101. In such an arrangement, the sensor 102 may be calibrated to account for the weight of the chamber 101 and/or the contents of the chamber 101 and then calculate the weight of only the 3D printed object.

The system also includes a processor 120 that can receive input from the sensor 102 and dispense fluid from the fluid dispenser 103 and stop the fluid dispenser 103 when a predetermined weight of the 3D printed object has been detected by the sensor 102. The processor 120 may be physically connected to the sensor 102 or the connection may be wireless. The processor 120 may also be physically connected to the fluid dispenser 103 or the connection may be wireless. The system may also comprise one or more fans, one or more condensers and one or more heaters to circulate and condense the fluid around the interior of the chamber as previously disclosed. The benefits and configuration of the fans, condensers and heaters that have been disclosed with reference the apparatus, apply to the system. The system may further comprise one or more trays onto which the 3D printed object can be disposed.

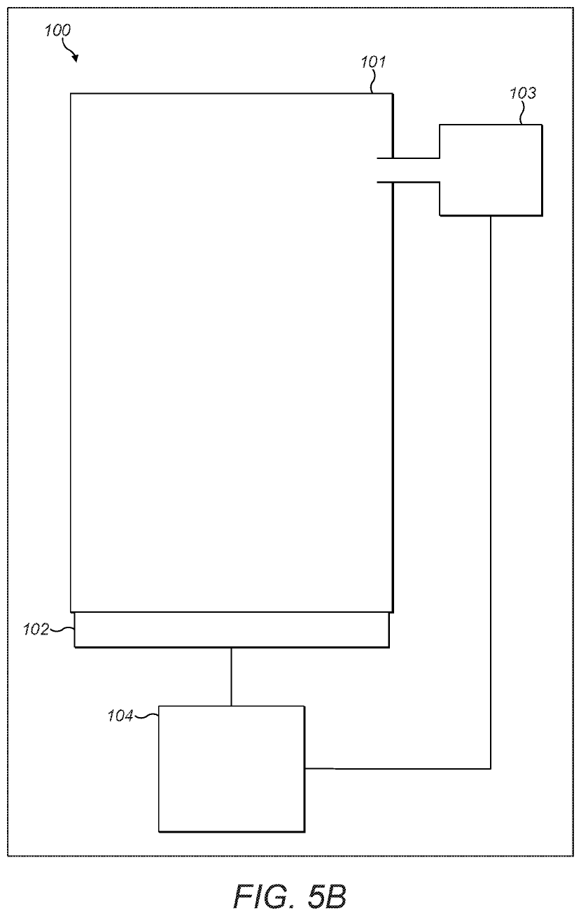

The system as shown in FIG. 6, comprises the chamber 101, which further comprises the sensor 102 and the fluid dispenser, and the processor 120. The processor 120 is set by the user to start at a particular time period and the processor 120 starts the fluid dispenser 103 to dispense fluid into the interior 130 of the chamber 101. The controller 104 may be set to stop the fluid dispenser 103 once a pre-set period of time has passed, allowing the amount of volume that is dispensed into the chamber 101 to be controlled. The processor 120 receives either continuous input or input at specific time periods from the sensor 102 on the weight of the 3D printed object or objects. This dispensing process can be done for a time period that is pre-programmed into the controller 104 or manually set into the controller 104 by the user. The time period will depend on the amount of volume that needs to be dispensed. The volume will depend on the size and the amount of 3D objects present and the size of the chamber 101. This automated system allows for the user to efficiently treat the 3D printed object in a controlled manner that allows interaction of the solvent with the 3D printed object, or saturation or absorption of the 3D printed object in a controlled environment. Such a system is cost beneficial as it reduces resources and time. In addition, the process can be implemented in a single system.

The processor 120 receives input from the sensor 102. The processor 120 can start the fluid dispensing process. For example, if the fluid dispenser 103 is in the form of a steam injector, a humidifier or a sprinkler, the processor 120 can start the injector, humidifier or sprinkler, allowing fluid or fluid vapor to be introduced into the interior 130 of the chamber 101. As another example, if the fluid dispenser 103 is in the form of a water tank or container 113, the processor 120 can turn on a heater to produce fluid or fluid vapor in the interior 130 of the chamber 101.

The processor 120 can determine the weight of the 3D printed object or 3D printed objects by receiving input from the sensor 102 as to the weight of 3D printed object before the addition of any fluid, as the sensor is calibrated to take account of the weight of the chamber 101 or the contents of the chamber 101. The processor 120 can start the fluid dispenser 103, allowing fluid into the chamber 101 and also stop the fluid dispenser 103. The processor 120 may stop the fluid dispenser 103 after a pre-set period of time. Any 3D printed objects present in the chamber 101 may then start to interaction with or absorb any fluid or fluid vapour that is in the chamber 101. After a pre-set period of time, the processor 120 may start the process of the fluid dispenser 103 extracting any fluid from the chamber 101 or the processor 120 may start and stop a separate fluid extractor if present (not depicted). The process of fluid extraction is then stopped by the processor 120. The processor 120 may then receive information from the sensor 102 as to the weight of the 3D printed object once the fluid has been extracted. The change in weight before the addition of fluid, and after the addition of fluid can be used as a measure of how much fluid has interacted with or been absorbed by the 3D printed object or object. The processor 120 may start the fluid dispenser 103 again if the 3D printed object or objects has not reached a predetermined weight. This cycle may be repeated until the 3D printed object or objects have reached the predetermined weight. The predetermined weight may be pre-programmed in to the processor 120. This may be done by connecting the processor 120 to a computer and/or software that calculates the predetermined weight based on the composition of the 3D printed object, the structure of the 3D printed object and the final desired level of absorption. The predetermined weight may also be pre-programmed in to the processor 120 by the user. The predetermined weight may be calculated based on the weight of the 3D printed object or objects, the fluid that is used and/or the material used in the 3D printed object or objects and the final levels of absorption that the user wants to achieve at the end of this process. The processor 120 may also be coupled to a display which alerts the user once the process is complete or the controller may be connected to an additional display which alerts the user once the process is complete. The processor 120 may receive information from the sensor 102 continuously or it may receive information at specific time periods depending on the sensor 102 that is being employed and where it is located. These time periods may be pre-programmed in to the processor 120 or may be set by the user. These time periods will be determined based on the amount of 3D printed objects that are being treated, the composition of the 3D printed objects and the required levels of interaction and/or absorption.

When the sensor 102 is in direct contact with the 3D printed object or objects, such as when the sensor 102 is in the form of a hanging sensor or the sensor 102 is present in a tray onto which the 3D printed object is disposed, the processor 120 may receive continuous input from sensor 102 which is continuously weighing the 3D printed object. The processor 120 may start the fluid dispenser 103. Once the predetermined weight has been reached and the processor 120 receives the input from the sensor 103, the processor 120 may then stop the fluid dispenser 103. If the fluid dispenser 103 is in the form of a steam injector, a humidifier or a sprinkler, the processor 120 may then stop the injector, humidifier or sprinkler. If the fluid dispenser 103 is in the form of a water tank or container 113, the controller 104 can turn off the heater 140.

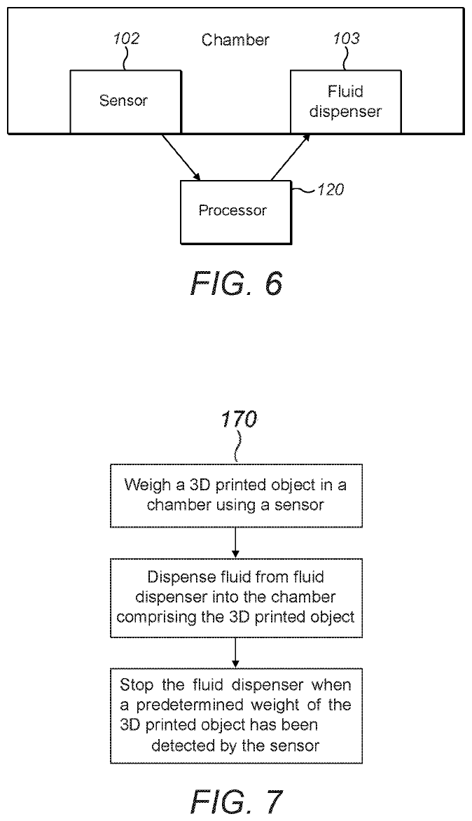

The present disclosure also provides a non-transitory machine-readable storage medium which may be encoded with instructions executable by a processor. As shown in FIG. 7 the machine-readable storage medium comprises: instructions 170 to weigh a 3D printed object in a chamber 101 using a sensor 102, dispense fluid from a fluid dispenser 103 into the chamber 101 comprising the 3D printed object and stop the fluid dispenser 103 when a predetermined weight of the 3D printed object has been detected by the sensor 102. The instructions 170 may comprise using a sensor 102 that weighs the chamber or the whole contents of the chamber 101 and calculates the weight of the 3D printed object. In another example, the instructions may comprise using a sensor 102 that weighs only the 3D printed object. The non-transitory machine-readable storage medium may include instructions 170 for dispensing fluid from a fluid dispenser for a pre-set period of time into the chamber 101. The instructions 170 may also include starting the fluid extraction process either via the fluid dispenser 103 or the extractor (not depicted) once a pre-set period time of fluid treatment has passed. The instructions 170 may also include repeating the cycle when a pre-determined weight of the 3D printed object has not been detected. The instructions 170 may also include starting the fluid extraction process via the fluid dispenser 103 or the extractor (not depicted) once the pre-determined weight has been reached. The instructions 170 may further include signalling on a display to the user that the process is complete. The instructions 170 may also include one or more of the process steps disclosed in reference to the controller 102, the processor 120 or with any of the examples or flow diagrams described above.

The machine readable storage medium may be any electronic, magnetic, optical or other physical storage device that stores executable instructions. Thus, the machine-readable storage medium may be, for example, Random Access Memory (RAM), an Electrically-Erasable Programmable Read-Only Memory (EEPROM), a storage drive, and optical disc, and the like.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. Apparatus comprising:
a chamber comprising an interior into which a 3D printed object can be disposed;
a sensor arranged to weigh the chamber or the whole contents of the chamber;
a fluid dispenser, the fluid dispenser being arranged to dispense fluid into the interior of the chamber; and
a controller to determine the weight of a 3D printed object in the chamber and control the fluid dispenser.

2. Apparatus in accordance with claim 1, wherein the fluid dispenser is selected from a steam injector, a humidifier, a sprinkler, a container, a water tank, a water vapor dispenser, or a combination thereof.

3. Apparatus in accordance with claim 1, wherein the apparatus further comprises one or more trays onto which a 3D printed object can be disposed and wherein the sensor is present in the tray.

4. Apparatus in accordance with claim 1, wherein the controller can control the fluid dispenser to dispense fluid for a pre-set period of time.

5. Apparatus in accordance with claim 1, wherein the controller is connected to the sensor and can determine the weight of the 3D printed object by receiving input from the sensor.

6. A system comprising:
a chamber comprising an interior into which a 3D printed object can be disposed;
a sensor that can weigh a 3D printed object in the chamber;
a fluid dispenser, the fluid dispenser being arranged to dispense fluid into the interior of the chamber to interact with the 3D printed object or to be absorbed by the 3D printed object; and
a processor to receive input from the sensor and dispense fluid from the fluid dispenser and to stop the fluid dispenser when a predetermined weight of the 3D printed object has been detected by the sensor.

7. A system in accordance with claim 6, wherein the fluid dispenser is selected from a steam injector, a humidifier, a sprinkler, a container, a water tank, a water vapor dispenser or a combination thereof.

8. A system in accordance with claim 6, wherein the system further comprises a tray onto which a 3D printed object can be disposed and wherein the sensor is present in the tray.

9. A system in accordance with claim 6, wherein the controller can control the fluid dispenser to dispense fluid for a pre-set period of time.

10. A system in accordance with claim 6, wherein the sensor weighs the chamber 101 or the whole contents of the chamber and calculates the weight of the 3D printed object.

11. A system in accordance with claim 6, wherein the sensor 102 directly weighs the 3D printed object.

12. A system in accordance with claim 6, wherein the system further comprises one or more trays onto which a 3D printed object can be disposed and wherein the sensor is present in the tray.

13. A non-transitory machine-readable storage medium encoded with instructions executable by a processor, the machine-readable storage medium comprising instructions to:
weigh a 3D printed object in a chamber using a sensor;
dispense fluid from a fluid dispenser into interior of the chamber comprising the 3D printed object; and
stop the fluid dispenser when a predetermined weight of the 3D printed object has been detected by the sensor.

14. A non-transitory machine-readable storage in accordance with claim 13, wherein the sensor weighs the chamber or the whole contents of the chamber and calculates the weight of the 3D printed object.

15. A non-transitory machine-readable storage in accordance with claim 13, wherein the sensor 102 weighs only the 3D printed object.
